(19) United States
(12) Patent Application Publication
(10) Pub. No.: US 2015/0160826 A1
(43) Pub. Date: Jun. 11, 2015

(54) Electronic Device

(71) Applicant: Funai Electric Co., Ltd., Osaka (JP)

(72) Inventor: Shusuke NARITA, Kyoto-shi (JP)

(21) Appl. No.: 14/564,356

(22) Filed: Dec. 9, 2014

(30) Foreign Application Priority Data
Dec. 10, 2013 (JP) 2013-255086

(51) Int. Cl. G06F 3/0481; G06F 3/0482

(52) U.S. Cl. CPC G06F 3/04817; G06F 3/0482

(57) ABSTRACT

An electronic device comprising a controller that performs a control of, in response to an operation input, selectively executing a plurality of kinds of application software and causing a display to display a plurality of icons each corresponding to each of the plurality of kinds of application software; and a storage that stores identification information that identifies whether each of the plurality of kinds of application software is normal application software or special application software, the controller performing a control of causing an icon corresponding to the normal application software to be displayed in a first mode on the display and causing an icon corresponding to the special application software to be displayed in a second mode on the display, the special application software being selectively executable by a user's operation that is different from an operation performed to execute the normal application software.

### BACKGROUND

1. Technical Field

An aspect of the present invention relates to an electronic device operable by remote control or the like and able to execute a plurality of kinds of application software, and particularly relates to an electronic device having an improved operability.

2. Related Art

Recently, electronic devices are becoming more and more function-rich, and thus some electronic devices require that the number of buttons provided in an operating remote control (also referred to as “remote controller”) or the like be increased or, in a case of not increasing the number of buttons provided in the operating remote control or the like, require that the button be operated more than one times. In such electronic devices, shortcut keys or shortcut icons may be provided for enabling functions frequently used by users to be executed with a simpler operation. For example, JP2012-123477A discloses a shortcut-icon registration method that enables a shortcut icon to be registered with a relatively simple operation. JP2007-53650A discloses a technique aimed at improving operability by facilitating registration of a shortcut key in television equipment.

The conventional techniques disclosed in JP2012-123477A and JP2007-53650A, however, involve a problem that a function assigned to a shortcut key or a shortcut icon is not readily checkable. Moreover, a device that is able to display a list of many kinds of application software is not even expected in the conventional techniques. A method suitable for such a device has not been provided.

### SUMMARY

The present invention has been made in view of the circumstances described above, and an object of the present invention is to provide an electronic device having an improved operability and able to execute a plurality of kinds of application software. Another object of the present invention is to enable a shortcut key for a specific function or the like to be easily registered in the electronic device that is able to execute a plurality of kinds of application software.

To solve the above-described problems, the present invention adopts the following means. The description given below contains the reference signs on the drawings being placed in parentheses, merely for facilitation of understanding of the present invention and not for limiting elements of the present invention. The elements should be construed as widely as within the technical purview of those skilled in the art.

An aspect of the present invention is an electronic device (information processing apparatus 10) including:

a controller (controller 110) that performs a control of, in response to an operation input (operation performed by a user), selectively executing a plurality of kinds of application software and causing a display (display 130) to display a plurality of icons each corresponding to each of the plurality of kinds of application software (see FIG. 2, etc.); and

a storage (memory 120) that stores identification information that identifies whether each of the plurality of kinds of application software is normal application software (application software not assigned to a one-touch app launching key) or special application software (application software assigned to a one-touch app launching key),

the controller performing a control of causing an icon corresponding to the normal application software to be displayed in a first mode (normal mode with no highlighting) on the display and causing an icon corresponding to the special application software to be displayed in a second mode (special mode with highlighting; see FIG. 6) on the display,

the special application software being selectively executable by a user's operation (pressing of a one-touch app launching key) that is different from an operation performed to execute the normal application software.

This aspect enables the user to recognize at a glance which application software is the special application software (the application software assigned to the one-touch app launching key) when icons of the plurality of kinds of application software are displayed on the display.

Another aspect of the present invention is an electronic device including the above-described aspect, wherein

the controller (controller 110) performs a control of, in response to an operation input (user's pressing of the one-touch app launching key) performed with the display displaying the plurality of icons (displaying a list of icons of application software; see FIG. 4), causing the storage to store identification information (identification information table) indicating that at least one of the plurality of kinds of application software is the special application software.

This aspect enables application software to be assigned to the one-touch app launching key (or a shortcut key) with a simple and intuitive operation.

Still another aspect of the present invention is an electronic device including the above-described aspect, wherein

the controller performs a control of switching a display state between a first display state (displaying a first page;

see FIG. 7) in which a first set of icons among the plurality of icons is displayed on the display and a second display state (displaying a second page; see FIG. 8) in which a second set of icons among the plurality of icons is displayed on the display, and performs a control of causing the display to display an icon (icons 601A to 604A registered to the one-touch app launching keys) corresponding to the special application software in both the first display state and the second display state (see FIGS. 7 and 8).

This aspect enables the user to readily check application software registered to the one-touch app launching keys even when many kinds of application software are registered so that there are a plurality of display states (displaying of a list of icons of the application software spans a plurality of pages).

Still another aspect of the present invention is an electronic device including the above-described aspect, further including

a transmitter (remote control transmitter-receiver 160 or Wi-Fi transmitter-receiver 150) that transmits information (application name and icon image data) concerning an icon of the special application software to an operation unit (smart device 30) that wirelessly operates the electronic device.

This aspect enables the icon of the special application software (the application software registered to the one-touch app launching key) to be displayed in the operation unit (smart device 30) side, too, which can provide further improvement in the operability.

### BRIEF DESCRIPTION OF THE DRAWINGS

FIG. 1 shows a system configuration;

FIG. 2 shows a display state of an information processing apparatus;

FIG. 3 is a front view of a remote control;

FIG. 4 shows a state of a smart device having launched a remote-control app;

FIG. 5 is a flowchart depicting a method for setting a one-touch app launching key;

FIG. 6 shows a display state of the information processing apparatus in which one-touch apps are highlighted;

FIG. 7 shows a display state of the information processing apparatus in which a first page is displayed according to an embodiment 2;

FIG. 8 shows a display state of the information processing apparatus in which a second page is displayed according to the embodiment 2;

FIG. 9 is a flowchart depicting a method for setting a one-touch app launching key according to an embodiment 3;

FIG. 10 is a flowchart depicting a remote-control app launching process according to the embodiment 3;

FIG. 11 shows a display state of the information processing apparatus before registration of a one-touch app according to the embodiment 3;

FIG. 12 shows a display state of a smart device according to the embodiment 3; and

FIG. 13 shows a display state of the information processing apparatus after the registration of the one-touch app according to the embodiment 3.

### DESCRIPTION OF EXEMPLARY EMBODIMENTS

A specific description of some embodiments of the present invention will be given as follows, with reference to the drawings. It should be noted that the embodiments described below are merely illustrative examples of the present invention and not to be construed as limiting the technical scope of the present invention. In the drawings, the same elements are denoted by the same reference signs, and repetitive description may be omitted.

1. Definitions

2. Embodiment 1
(1) System Configuration
(2) Configuration of Information Processing Apparatus
(3) Configuration of Remote Control
(4) Configuration of Smart Device
(5) Operations of Elements
(6) Method for Setting One-Touch App Launching Key
(7) Display Mode on Display

3. Embodiment 2

4. Embodiment 3
(1) Method for Setting One-Touch App Launching Key
(2) Remote-Control App Launching Process
(3) Displaying on Display with One-Touch App Launching Key Set

5. Supplementary Remarks
(1. Definition)

The terms used in this specification are defined as follows. Interpretation of the terms, however, should be neither limited nor expanded only by the following definitions, and how those skilled in the art can appreciate based on the principles of the present invention is also considered.

“Application software” means software that is executed based on a certain program, and in this specification, may be called “app”.

“Remote control” means an operation terminal operable to wirelessly operate a certain apparatus, and may be called “remote controller”.

“Smart device” means a device operable to execute an app, and in this specification, means a device operable to execute at least a remote-control app.

“One-touch app launching key” means a key (button) that, when pressed by a user, causes selective execution of a certain app (one-touch app), and in this specification, may be called “shortcut key”. Here, “one-touch” does not always mean that a user performs touch-based operation once. It also means, for example, pressing a second key while pressing a first key.

“Key” means an operation region touchable by a user. It may not necessarily be a physical key (button) but includes, for example, a region of a touch panel displayed in the form of keys.

“Press” means user's pressing of a key. In a case where the operation region is a touch panel, “press” includes a touch-based operation, too. “Selectively execute” means launching and executing an app, or selectively causing an app that is in a standby state to transit to an active state.

(2. Embodiment 1)

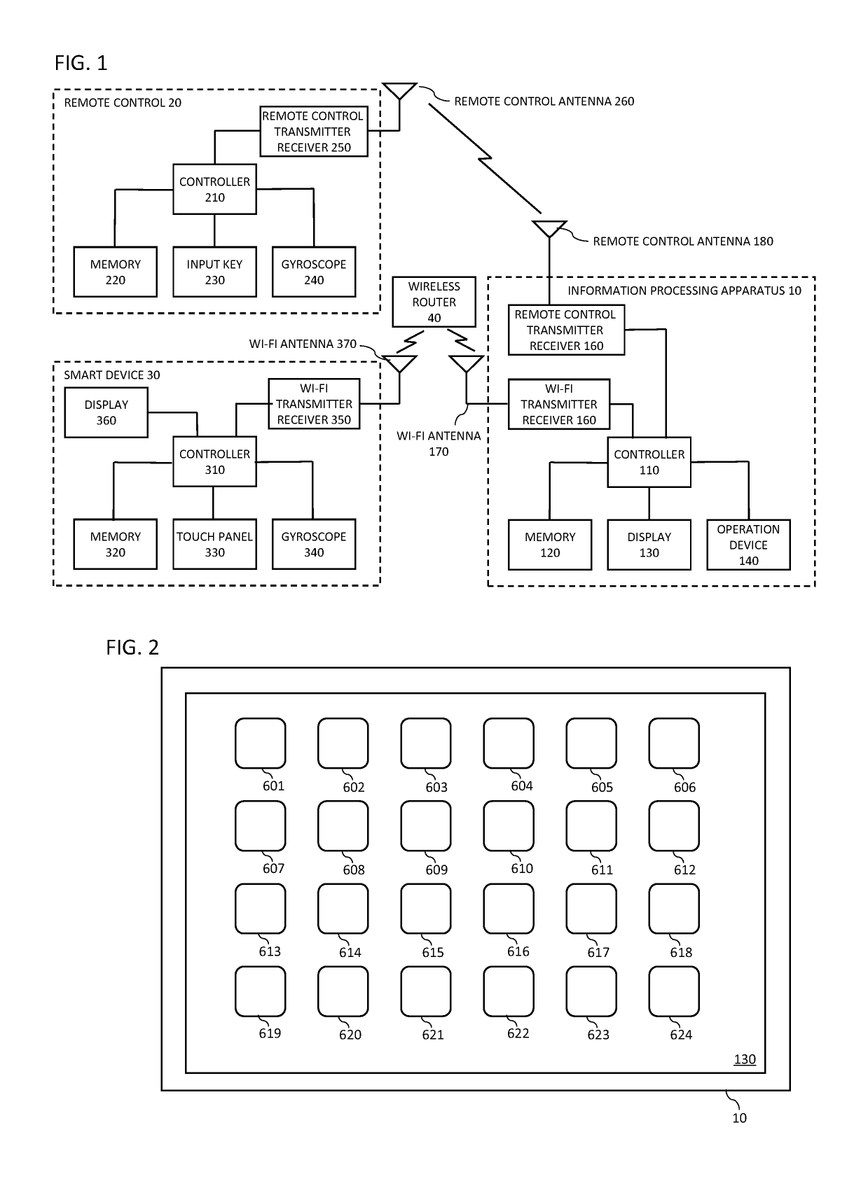

An embodiment 1 of the present invention will be described with reference to FIGS. 1 to 6.

((1) System Configuration)

FIG. 1 shows a system configuration according to the present invention. As shown in FIG. 1, a system according to the present invention includes an information processing apparatus 10, a remote control 20, and a smart device 30. The information processing apparatus 10 is operable to wirelessly transmit and receive signals to and from the remote control 20 via a remote control antenna 180 and a remote control antenna 260. The information processing apparatus 10 is operable to wirelessly transmit and receive signals to and from the smart device 30 via a Wi-Fi antenna 170, a Wi-Fi antenna 370, and a wireless router 40. Each of the remote control 20 and the smart device 30 is operable to transmit a predetermined signal to the information processing apparatus 10 in response to an operation performed by a user. The system may be used in combination of the information processing apparatus 10 and the remote control 20 or in combination of the information processing apparatus 10 and the smart device 30.

((2) Configuration of Information Processing Apparatus)

The information processing apparatus 10 is an apparatus operable to execute a plurality of kinds of application software (apps). The information processing apparatus 10 is operable to display on a display 130 a plurality of icons each corresponding to each of the plurality of apps. Although the description herein illustrates a case where the display 130 is a part of the information processing apparatus 10, it is not essential that the information processing apparatus 10 includes the display 130 as an element thereof. In a case where the information processing apparatus 10 is an apparatus like a television, it includes the display 130. In some cases, the information processing apparatus 10 may be an apparatus like a set top box (STB), for example. In such a case, the display 130 is provided as a device external to and separate from the information processing apparatus 10 and connected to the information processing apparatus 10.

As shown in FIG. 1, the information processing apparatus 10 includes a controller 110, a memory 120, a display 130, an operation unit 140, a Wi-Fi transmitter-receiver 150, a remote control transmitter-receiver 160, and a remote control antenna 180.

(Controller 110)

The controller 110 is operable to execute an app stored in the memory 120 and to control other elements based on a result of the execution or input signals supplied from other elements. The controller 110 is also operable to, in accordance with a result of execution of an app, cause the display 130 to display predetermined information, cause the memory 120 to store predetermined information, or instruct the Wi-Fi transmitter-receiver 150 to transmit a predetermined signal to the smart device 30. The controller 110 is also operable to selectively execute a plurality of apps in response to an operation input signal supplied from the operation unit 140. The controller 110 is operable to perform a control of causing a plurality of icons each corresponding to each of a plurality of executable apps stored in the memory 120 to be displayed in a normal mode or a special mode on the display 130. The special mode means a mode that allows visual observation that an app corresponding to an icon is registered as a one-touch app, and the normal mode means an ordinary mode different from the special mode, as will be described later.

The controller 110 is also operable to, in response to an operation input that the user has performed through the operation unit 140 with the display 130 displaying a plurality of icons, execute processing for causing the memory 120 to store predetermined identification information for assignment of an app identified by the user as the one-touch app, as will be described later.

(Memory 120)

The memory 120, which stores programs of the plurality of apps, is operable to store various kinds of information including the identification information. Among the programs of the plurality of apps, apps (also called “one-touch apps”) assigned to one-touch app launching keys (described later) are stored in the form of an identification information table in the memory 120. That is, the memory 120 stores associated correspondence between one-touch app launching keys and apps. The memory 120 is operable to transmit information stored therein to the controller 110 as appropriate in accordance with a request from the controller 110.

(Display 130)

The display 130 is operable to display predetermined information based on an instruction given from the controller 110. For example, the display 130 displays a plurality of icons each corresponding to each of a plurality of apps, or displays a result of execution of an app. An LCD, an organic EL display, or the like, is adoptable as the display 130. The display 130 is not necessarily integrated with the information processing apparatus 10, but may be provided as a device external to the information processing apparatus 10.

FIG. 2 shows an exemplary display state of the display 130 of the information processing apparatus 10. In FIG. 2, a list of app icons is displayed on the display 130. In the display, icons 601 to 624 are arranged. When the user makes a predetermined input by using the remote control 20, a pointer or cursor (not shown) is moved in the display, or an app corresponding to the icon positioned under the pointer or cursor is executed.

(Operation unit 140)

The operation unit 140 is operable to receive an operation performed by the user and transmit to the controller 110 an operation input signal corresponding to the operation. The operation unit 140 may be in the form of either physical keys (buttons) or key-like icons displayed on a touch panel. In some cases, a signal received from the remote control 20 or the smart device 30 instead of the operation unit 140 may serve as an operation input signal that is to be subjected to processing. In such a case, the information processing apparatus 10 may not necessarily include the operation unit 140.

(Wi-Fi Transmitter-Receiver 150)

The Wi-Fi transmitter-receiver 150 is operable to wirelessly transmit a predetermined signal via the Wi-Fi antenna 170 based on an instruction given from the controller 110. The Wi-Fi transmitter-receiver 150 is also operable to receive a signal via the Wi-Fi antenna 170 and output the signal to the controller 110. The signal transmitted via the Wi-Fi antenna 170 can be, through the wireless router 40, received by the Wi-Fi antenna 370 of the smart device 30.

(Remote Control Transmitter-Receiver 160)

The remote control transmitter-receiver 160 is operable to wirelessly, for example, through infrared communication, transmit a predetermined signal via the remote control antenna 180 based on an instruction given from the controller 110. The remote control transmitter-receiver 160 is also operable to receive a signal via the remote control antenna 180 and output the signal to the controller 110. The signal transmitted via the remote control antenna 180 is received by the remote control antenna 260 of the remote control 20.

(Wi-Fi Antenna 170)

The Wi-Fi antenna 170 is operable to transmit a wireless signal based on an input signal supplied from the Wi-Fi transmitter-receiver 150, or to receive a wireless signal transmitted from the smart device 30 and output the wireless signal to the Wi-Fi transmitter-receiver 150.

(Remote Control Antenna 180)

The remote control antenna 180 is operable to transmit a wireless signal based on an input signal supplied from the remote control transmitter-receiver 160, or to receive a wireless signal transmitted from the remote control 20 and output the wireless signal to the remote control transmitter-receiver 160.

((3) Configuration of Remote Control)

The remote control 20, which is a remote controller capable of remotely operating the information processing apparatus 10, is operable to operate the information processing apparatus 10 via the remote control antenna 260 and the remote control antenna 180 included in the information processing apparatus 10 in accordance with an operation performed by the user. As shown in FIG. 1, the remote control 20 includes a controller 210, a memory 220, an input key 230, a gyroscope 240, a remote control transmitter-receiver 250, and a remote control antenna 260.

(Controller 210)

The controller 210 is operable to access the memory 220 as necessary in response to an external input inputted from the input key 230 or the gyroscope 240, and instruct the remote control transmitter-receiver 250 to transmit a wireless signal via the remote control antenna 260.

(Memory 220)

The memory 220, which is, for example, a non-volatile memory capable of storing information, is operable to output the information stored therein to the controller 210. The memory 220 stores, for example, a table of combinations between each one-touch app launching key included in the input key 230 and a signal that is to be transmitted to the information processing apparatus 10 in response to pressing of the one-touch app launching key.

(Input Key 230)

The input key 230, which includes a plurality of keys (buttons) serving to be pressed by the user, is operable to detect the user's pressing of a key and output an operation input signal corresponding to the key to the controller 210.

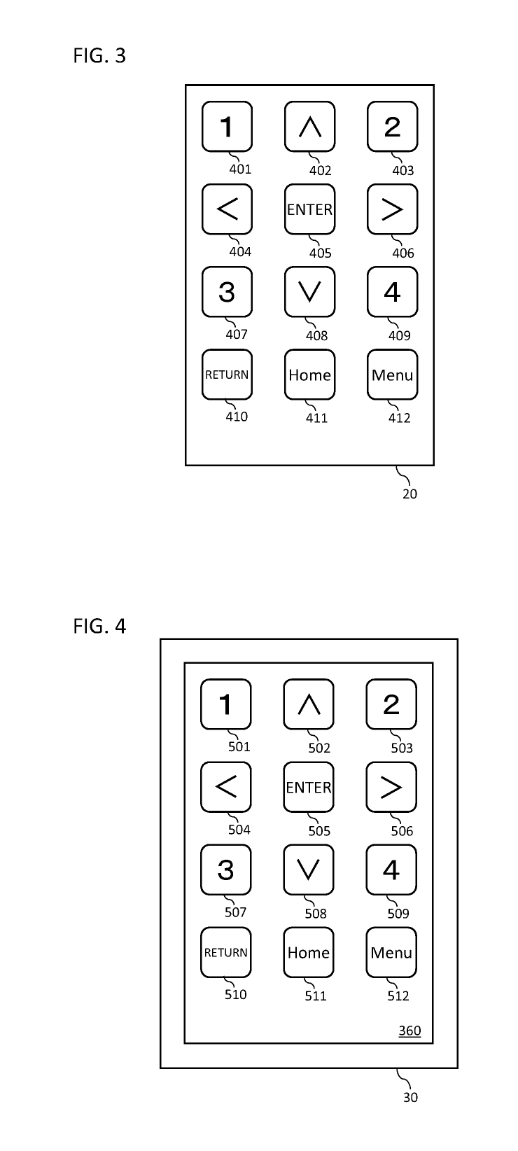

FIG. 3 is a front view of the remote control 20. Keys 401 to 412 (referred to collectively as the input key 230) are arranged on a surface of the remote control 20. Among the keys, the keys 401, 403, 407, and 409 are one-touch app launching keys which, when pressed by the user, cause the remote control transmitter-receiver 250 to transmit a predetermined wireless signal via the remote control antenna 260 under control by the controller 210. The wireless signal includes information notifying that a certain one-touch app launching key has been pressed or an ID of an app that should be launched.

(Gyroscope 240)

The gyroscope 240 is a generally-known device capable of detecting the angular velocity. Herein, the gyroscope 240 is operable to detect the angular velocity involved in movement of the remote control 20 and output a signal of the detection to the controller 210. The gyroscope 240 may be replaced with a movement detection device having the same function as that of the gyroscope 240.

(Remote Control Transmitter-Receiver 250)

The remote control transmitter-receiver 250 is operable to wirelessly transmit and receive signals to and from the information processing apparatus 10 via the remote control antenna 260. To be more specific, the remote control transmitter-receiver 250 is operable to transmit a predetermined wireless signal via the remote control antenna 260 based on a control by the controller 210, and to output a signal received by the remote control antenna 260 to the controller 210.

(Remote Control Antenna 260)

The remote control antenna 260 is operable to transmit a wireless signal based on an input signal supplied from the remote control transmitter-receiver 250, or to receive a wireless signal transmitted by the information processing apparatus 10 and output the wireless signal to the remote control transmitter-receiver 250.

((4) Configuration of Smart Device)

The smart device 30 is a device capable of executing a plurality of apps. Examples of the smart device 30 include so-called smart phones, tablet devices, and the like. The smart device 30 of the present invention is operable to execute a remote-control app that is one of the plurality of apps, and this execution enables the smart device 30 to offer the same performance as that of the remote control 20.

As shown in FIG. 1, the smart device 30 includes a controller 310, a memory 320, a touch panel 330, a gyroscope 340, a Wi-Fi transmitter-receiver 350, a display 360, and a Wi-Fi antenna 370.

(Controller 310)

The controller 310 is operable to execute the apps stored in the memory 320, and operable to control other elements based on results of the execution and input signals supplied from the other elements. The controller 310 is operable to, in accordance with the results of the execution of the apps, cause the display 360 to display predetermined information, cause the memory 320 to store predetermined information, or instruct the Wi-Fi transmitter-receiver 350 to transmit a predetermined signal to the information processing apparatus 10.

The controller 310 is also operable to execute the remote-control app stored in the memory 320 as mentioned above. The execution of the remote-control app enables the smart device 30 to offer the same performance as that of the remote control 20. Details of the performance will be described later.

(Memory 320)

The memory 320, which stores programs of a plurality of apps, is operable to store various kinds of information including the identification information. The memory 320 is operable to transmit information stored therein to the controller 310 as appropriate in accordance with a request from the controller 310. The memory 320 stores at least the remote-control app, as mentioned above.

(Touch Panel 330)

The touch panel 330 is operable to detect, for example, pressure applied by the user's touching, and transmit a result of the detection to the controller 310. Therefore, the user is able to operate the smart device 30 by bringing a medium such as the user's finger or a stylus pen close to or into contact with the touch panel 330.

(Gyroscope 340)

The gyroscope 340 is, similarly to the gyroscope 240 of the remote control 20, a device capable of detecting the generally-known angular velocity. Herein, the gyroscope 340 is operable to detect the angular velocity involved in movement of the smart device 30 and output a signal of the detection to the controller 310. The gyroscope 340 may be replaced with a movement detection device having the same function as that of the gyroscope 340.

(Wi-Fi Transmitter-Receiver 350)

The Wi-Fi transmitter-receiver 350 is operable to wirelessly transmit a signal via the Wi-Fi antenna 370 based on an instruction given from the controller 310. The Wi-Fi transmitter-receiver 350 is also operable to receive a signal via the Wi-Fi antenna 370 and output the signal to the controller 310. The signal transmitted via the Wi-Fi antenna 370 can be, through the wireless router 40, received by the Wi-Fi antenna 170 of the information processing apparatus 10.

(Display 360)

The display 360 is operable to display predetermined information based on an instruction given from the controller 310. For example, the display 360 displays a plurality of icons each corresponding to each of a plurality of apps executed by the controller 310, or displays a result of execution of an app. In a case where the controller 310 executes the remote-control app, the display 360 displays a screen similar to the screen of the remote control, so that functions similar to the functions of the remote control can be performed and operated. An LCD, an organic EL display, or the like, is adoptable as the display 360.

FIG. 4 shows an exemplary display state of the display 360 of the smart device 30. The state of the display 360 shown in FIG. 4 is a state obtained when the controller 310 executes the remote-control app. In the display, virtual keys 501 to 512 are arranged. Comparison between FIGS. 3 and 4 shows that the virtual keys 501 to 512 are arranged in the same manner as the keys 401 to 412 of the input key 230 of the remote control. As can be understood from this, execution of the remote-control app by the controller 310 enables the smart device 30 to exert the same functions as those of the remote control 20. In the smart device 30 as well as the remote control 20, the virtual keys 501, 503, 507, and 509 are one-touch app launching keys. Here, the virtual key is an illustrative embodiment of “icon”, and it means the “icon” resembling the input key 230 of the remote control 20

(Wi-Fi Antenna 370)

The Wi-Fi antenna 370 is operable to transmit a wireless signal based on an input signal supplied from the Wi-Fi transmitter-receiver 350, or to receive a wireless signal transmitted by the information processing apparatus 10 and output the wireless signal to the Wi-Fi transmitter-receiver 350.

((5) Operations of Elements)

Next, with reference to FIGS. 1 to 4, a specific description will be given of operations of the respective elements at a time when the one-touch app launching key is operated.

Firstly, how the information processing apparatus 10 operates in response to the user's operation on the remote control 20 will be briefly described. In a case where the user operates the remote control 20, the controller 210 detects the user's pressing of any of the keys 401 to 412 of the remote control 20, and executes the function corresponding to the pressed key. For example, upon the user's pressing of the key 402, the controller 210 instructs the remote control transmitter-receiver 250 to transmit a wireless signal requesting upward movement of the pointer or cursor displayed on the display 130 of the information processing apparatus 10. Based on the instruction, the remote control transmitter-receiver 250 transmits a signal corresponding to the instruction via the remote control antenna 260. The remote control antenna 180 of the information processing apparatus 10 receives the signal, and then the remote control transmitter-receiver 160 outputs the received signal to the controller 110. Based on the received signal, the controller 110 performs a control of updating the display so as to cause upward movement of the pointer or cursor displayed on the display 130.

Next, an operation caused when the user presses the one-touch app launching key of the remote control 20 will be described. The controller 210 detects the user's pressing of the one-touch app launching key 401 of the remote control 20, and instructs the remote control transmitter-receiver 250 to transmit a wireless signal requesting launch of an app corresponding to the one-touch app launching key 401. Based on the instruction, the remote control transmitter-receiver 250 transmits a signal corresponding to the instruction via the remote control antenna 260. The remote control antenna 180 of the information processing apparatus 10 receives the signal, and then the remote control transmitter-receiver 160 outputs the received signal to the controller 110. After the controller 110 determines that the received signal is a signal corresponding to the pressing of the one-touch app launching key 401, the controller 110 refers to the identification information table stored in the memory 120 and identifies the associated correspondence between the one-touch app launching keys and apps, for identification of the app corresponding to the one-touch app launching key 401. Thereby, the controller 110 identifies the app corresponding to the one-touch app launching key 410, and executes the program corresponding to this app from the memory 120.

A case where the user operates the smart device 30 instead of the remote control 20 will be described. In a case where the remote-control app is executed, the smart device 30 is able to offer the same performance as that of the remote control 20 as described above, except that the user operates the touch panel 330 instead of the input key 230 and that communication of wireless signals with the information processing apparatus 10 is not via the remote control antennas but via the Wi-Fi antennas and the wireless router 40. There is no other significant difference.

((6) Method for Setting One-touch App Launching Key)

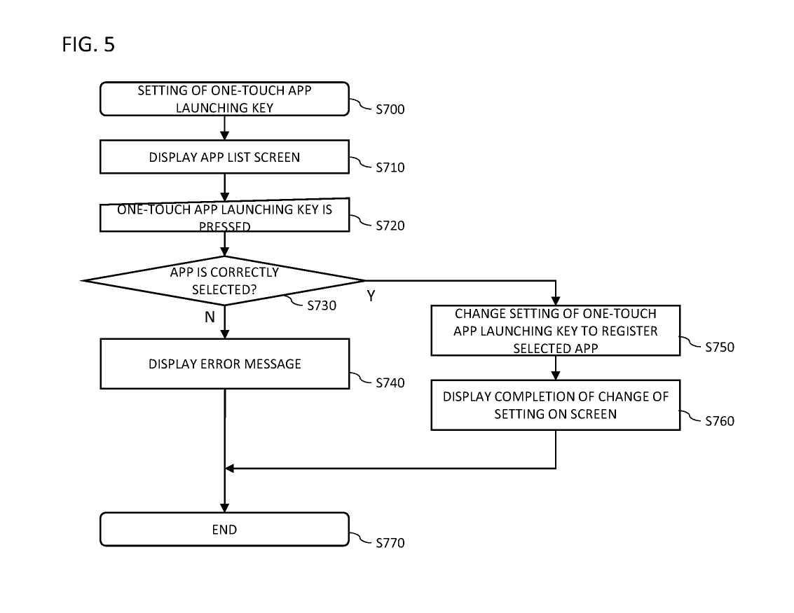

Next, a method for setting the one-touch app launching key will be described. FIG. 5 is a flowchart showing a method for setting the one-touch app launching key. In short, the feature of setting of the one-touch app launching key according to the present invention lies in that, in response to the user's pressing of the one-touch app launching key with the display 130 displaying a plurality of icons each corresponding to each of a plurality of apps, the controller 110 causes the memory 120 to store identification information in such a manner that the app selected at this time is associated with the one-touch app launching key pressed at this time. The following description illustrates an operation using the remote control 20 as an example, but the same applies to an operation using the remote-control app of the smart device 30.

(S700 to S740, S770)

Triggered by the user's operation on the remote control 20, setting of the one-touch app launching key is started in the information processing apparatus 10 (S700), and in response to this, the controller 110 causes the display 130 to display an app list screen (S710; see FIG. 2). When any of the one-touch app launching keys 401, 403, 407, and 409 is pressed on the app list screen (S720), the controller 110 of the information processing apparatus 10 determines whether or not an app is correctly selected (S730). More specifically, it determines whether or not the pointer or cursor is located on any of the icons 601 to 624 corresponding to apps. If an app is not correctly selected (S730: N), the controller 110 causes the display 130 to display an error message saying “select app” (S740), and ends a one-touch app launching key setting process (S770).

(S750, 5760)

If the determination in S730 made by the controller 110 results in that an app is correctly selected (S730: Y), the controller 110 executes processing for changing the setting of the one-touch app launching key so as to register the selected app to the one-touch app launching key (S750). At this time, a message saying “change setting?” with selection buttons of “Yes” and “No” may be conceivably displayed on the display 130. In such a case, the processing of S750 may be executed only if the user selects “Yes”. More specifically, the controller 110 performs a control of storing into the memory 120 the associated correspondence between the selected app and the pressed one-touch app launching key in the form of an identification information table. Then, the controller 110 causes the display 130 to display that the setting of the one-touch app launching key has been changed (S760), and ends the process.

As a result, subsequent pressing of the one-touch app launching key 401, 403, 407, or 409 of the remote control causes the controller 110 to refer to the identification information table stored in the memory 120 and launch the app identified based on the updated correspondence.

Although launching of an app has been described above, the embodiment also includes shifting the state of an app from the standby state to the active state in response to pressing of the one-touch app launching key.

Executing the setting of the one-touch app launching key through the above-described process enables an app to be assigned to the one-touch app launching key with a simple and intuitive operation.

((7) Display Mode on Display)

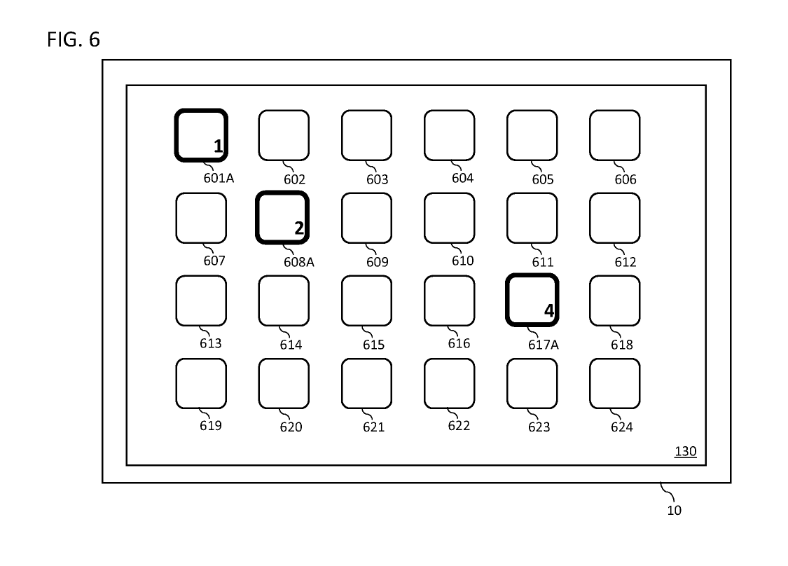

FIG. 6 shows a state where a list of apps is displayed on the display 130 of the information processing apparatus 10. In the display state of the display 130 displaying a list of apps shown in FIG. 6, apps each corresponding to each of icons 601A, 608A, and 617A have been associated with the one-touch app launching keys 401, 403, and 409, respectively, as a result of the above-described one-touch app launching key setting process. In the state shown in FIG. 6, as compared with the state before the one-touch app launching key setting process (see FIG. 2), the display mode of the icons 601A, 608A, and 617A (corresponding to 601, 608, and 617 of FIG. 2, respectively) is changed. That is, at a time of displaying a list of apps on the display 130, the controller 110 causes the apps assigned to the one-touch app launching keys to be displayed in a special mode different from a normal mode. In this embodiment, the normal mode is a mode in which an icon corresponding to an app is displayed without any change, and the special mode is a mode in which an icon corresponding to an app is given a thick red outline and a numeric character representing the corresponding one-touch app launching key is given in the lower right portion of the icon.

Selectively adopting the normal mode or the special mode as the display mode of the display 130 in the above-described manner allows the user to recognize at a glance which app is assigned to which one-touch app launching key.

(3. Embodiment 2)

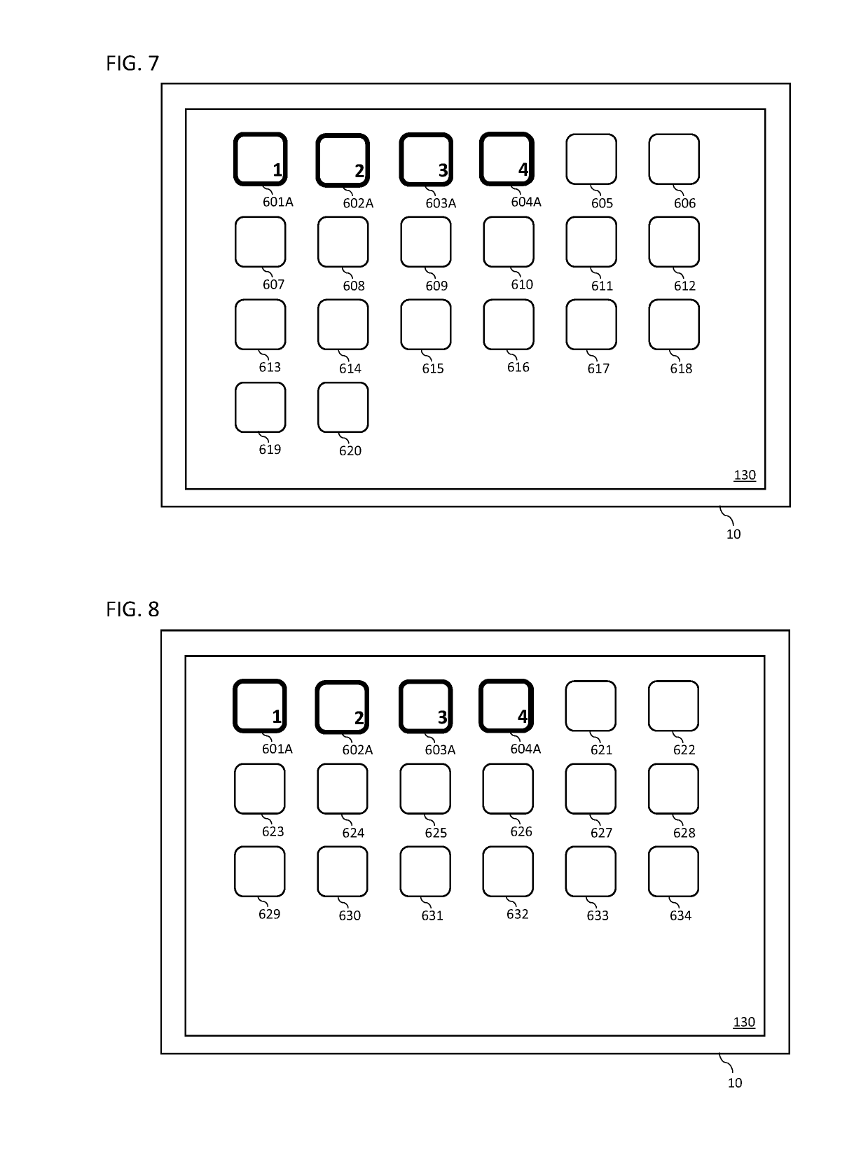

Next, an embodiment 2 of the present invention will be described with reference to FIGS. 7 and 8. Since the feature of the embodiment 2 lies in displaying of a list of apps on the display 130, the displaying of a list of apps will be detailed below. The same points as those of the embodiment 1 will not be described below.

FIG. 7 shows a state where a first page of a list of icons each corresponding to each of a plurality of apps is displayed on the display 130 of the information processing apparatus 10. FIG. 8 shows a state where a second page of the list of icons each corresponding to each of the plurality of apps is displayed on the display 130 of the information processing apparatus 10.

Referring to FIG. 7 showing the first page, icons 601A to 604A each of which corresponds to an app associated with a one-touch app launching key are displayed in the special mode on the display 130. Additionally, icons 605 to 620 each of which corresponds to an app not associated with any one-touch app launching key are displayed in the normal mode on the display 130.

Referring to FIG. 8 showing the second page, the icons 601A to 604A each of which corresponds to the app associated with the one-touch app launching key are displayed in the special mode on the display 130. Additionally, icons 621 to 634 each of which corresponds to an app not associated with any one-touch app launching key are displayed in the normal mode on the display 130.

In this embodiment, as described above, a plurality of pages for displaying a list of icons are set in the information processing apparatus 10, and the controller 110 is operable to switch the display among the plurality of pages upon the user's operation. In principle, a set of icons corresponding to different apps is displayed in each of the plurality of pages, with the exception that the controller 110 controls the display 130 such that the icons corresponding to the apps assigned to the one-touch app launching keys are displayed in all the pages.

Thus, in this embodiment, in a case where a plurality of pages for displaying a list of icons are set, icons of apps associated with the one-touch app launching keys are displayed in any of the plurality of pages. This enables the user to readily check the icons of the apps assigned to the one-touch app launching keys even when there are many apps executable in the information processing apparatus 10 so that displaying of a list of icons of the apps spans many pages.

(4. Embodiment 3)

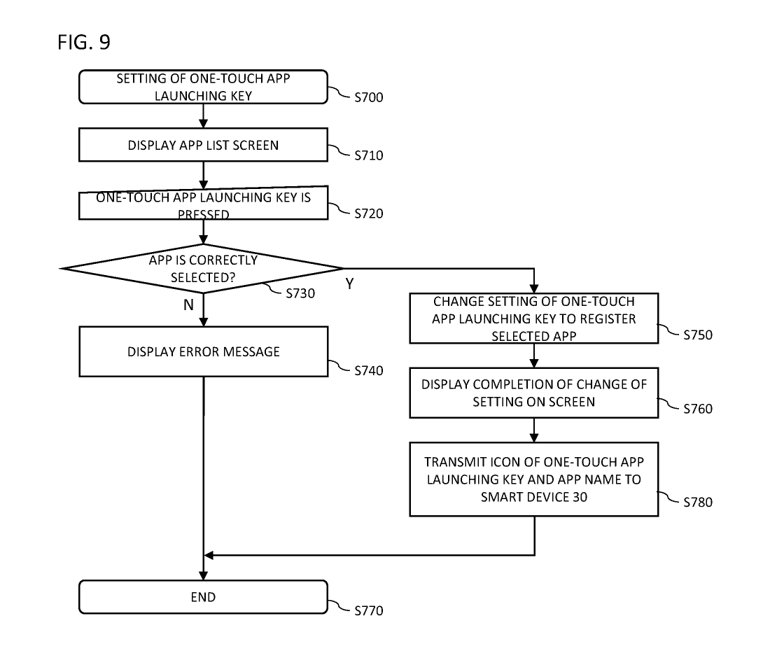

Next, an embodiment 3 of the present invention will be described with reference to FIGS. 9 to 13. Since the feature of the embodiment 3 lies in communication between the information processing apparatus 10 and the smart device 30 at a time of setting the one-touch app launching key and in displaying of keys at a time of launching the remote-control app in the smart device 30, these points will be mainly described. The same points as those of the embodiments 1 and 2 will not be specifically described below.

((1) Method for Setting One-Touch App Launching Key)

FIG. 9 is a flowchart showing a method for setting the one-touch app launching key according to this embodiment. It is different from the flowchart of FIG. 5 showing the method for setting the one-touch app launching key according to the embodiment 1, in that processing of S780 is additionally provided after the processing of S760. There is no other difference.

(S780)

As has been described in the embodiment 1, the controller 110 executes the processing for changing the setting of the one-touch app launching key so as to register the app selected by the user to the one-touch app launching key (S750), and then causes the display 130 to display that the setting of the one-touch app launching key has been changed (S760). Then, in this embodiment, the controller 110 transmits, to the smart device 30, the icon of the app associated with the one-touch app launching key and information about the name of this app. A specific content of the processing of S780 is as follows.

The controller 110 of the information processing apparatus 10 obtains, from the memory 120, image data of the icon of the app associated with the one-touch app launching key and information about the name of this app. Then, the controller 110 outputs the obtained information to the Wi-Fi transmitter-receiver 150, with instructing the Wi-Fi transmitter-receiver 150 to transmit the information to the smart device 30. Based on the instruction, the Wi-Fi transmitter-receiver 150 transmits the app information via the Wi-Fi antenna 170. The app information thus transmitted is, through the wireless router 40, received by the Wi-Fi antenna 370 of the smart device 30. The Wi-Fi antenna 370 outputs the received app information to the Wi-Fi transmitter-receiver 350. The Wi-Fi transmitter-receiver 350 outputs the app information received as an input signal, to the controller 310. The controller 310 stores the app information into the memory 320. Here, the app information is stored as the icon of the app associated with the certain one-touch app launching key. Upon subsequent execution of the remote-control app in the smart device 30, the icon and the app name generated based on the app information are displayed in an area corresponding to the one-touch app launching key on the display 360.

((2) Remote-Control App Launching Process)

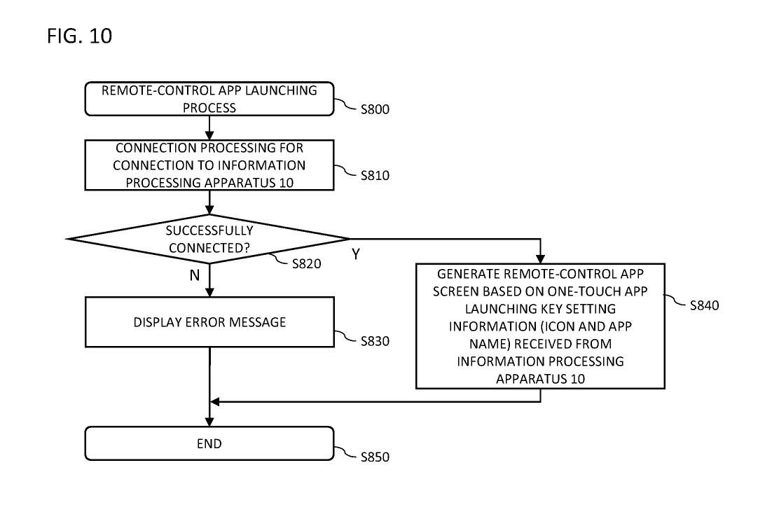

The smart device 30 that receives this information, on the other hand, executes the following process shown in FIG. 10 at a time of launching the remote-control app. This process is, in consideration of the fact that the information processing apparatus 10 can be operated from both the remote control 20 and the smart device 30, executed for the purpose of reflecting a change of the setting of the one-touch app launching key made in the remote control 20 to the smart device 30, too.

(S800 to S830, S850)

In response to the user's operation on the touch panel 330, the controller 310 of the smart device 30 launches the remote-control app stored in the memory 320 (S800), and then the controller 310 performs connection processing for the connection to the information processing apparatus 10 (S810). If the connection processing fails (S820: N), the controller 310 causes the display 360 to display an error message saying that the connection processing for the connection to the information processing apparatus 10 has failed (S830), and ends the remote-control app (S850).

(S840)

If the connection processing of S810 results in the smart device 30 successfully connecting to the information processing apparatus 10 (S820: Y), the controller 310 receives a set of information concerning the one-touch app launching key from the information processing apparatus 10. The set of information includes the names of the apps each assigned to each of the one-touch app launching keys and the image data of icons corresponding to the apps. The controller 310 generates a remote-control app screen based on the set of information, and causes the display 360 to display the generated screen (S840). Then, the controller 310 ends the remote-control app launching process (S850).

((3) Displaying on Display with One-Touch App Launching Key Set)

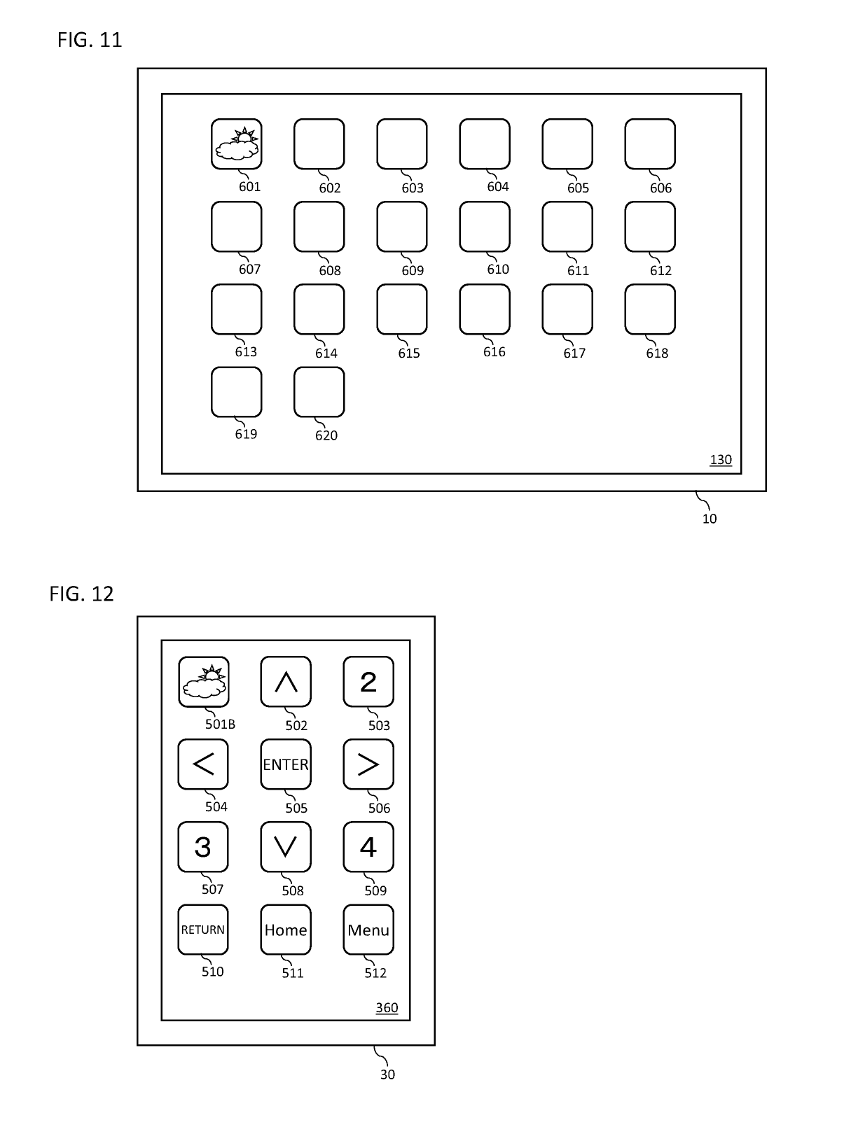

With reference to FIGS. 11 to 13, a specific description will be given of displaying on the display 130 of the information processing apparatus 10 and displaying on the display 360 of the smart device 30 at a time when the one-touch app launching key is set in the above-described manner.

FIG. 11 shows an example of displaying of the app list screen on the display 130 of the information processing apparatus 10 before an app is registered to the one-touch app launching key. Each of a plurality of icons displayed on the display 130 is provided with an image. In the example illustrated in FIG. 11, the icon 601 is provided with an image concerning a weather app. Actually, the icons 602 to 620 are also provided with images of icons corresponding to apps, respectively.

Here, assumed is a situation where the user operates the smart device 30 and sets the weather app represented by the above-mentioned icon 601 to a one-touch app launching key 501B. In this situation, the setting of the one-touch app launching key illustrated in FIG. 9 is executed in the information processing apparatus 10. Execution of the processing of S780 included in the one-touch app launching key setting process causes the icon of the weather app and the app name (not shown) of the weather app to be displayed at the one-touch app launching key 501B of the smart device 30, as shown in FIG. 12. The image data and the app name of the app have been transmitted from the information processing apparatus 10 to the smart device 30 through the communication via the Wi-Fi antennas and the wireless router 40, as already described above.

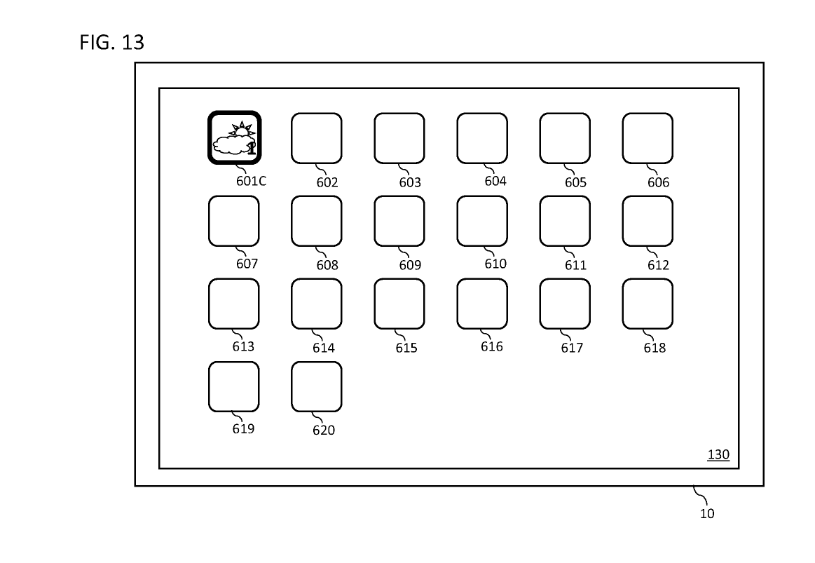

On the other hand, displaying on the information processing apparatus 10 is also changed, as shown in FIG. 13. An icon 601B of the weather app that has been displayed in the normal mode before the setting of the one-touch app launching key is changed into an icon 601C of the weather app that is displayed in the special mode, with the app name displayed thereunder.

In this manner, the information processing apparatus 10 transmits to the smart device 30 the image data of the icon and the app name of the app registered to the one-touch app launching key, thereby enabling the smart device 30 to display the icon and the app name relating to the one-touch app launching key, as described above. This enables the user to readily recognize the information of the app that has been set to the one-touch app launching key of the smart device 30. Thus, further improvement in the operability for the user can be achieved.

(5. Supplementary Remarks)

Hereinbefore, specific descriptions of the embodiments 1 to 3 of the present invention have been given. These embodiments are merely illustrative. The scope of the present invention is not restricted to these illustrative embodiments. The present invention should be construed as widely as those skilled in the art can appreciate.

Although the above description illustrates the case where the one-touch app is an app that is selected and launched by the one-touch app launching key being pressed or operated, it is not essential that the app is selected and launched by pressing of or operation on the one-touch app launching key alone. It may be also acceptable that the app is selected and launched by the one-touch app launching key as well as another key being pressed or operated simultaneously or by the one-touch app launching key being pressed or operated after another key being pressed or operated. Preferably, however, the one-touch app launching key is configured to be operated by the user's one-time operation, because it contributes to improvement in the operability.

In the system according to the present invention, the information processing apparatus 10 communicates with the remote control 20 or the smart device 30 via wireless communication using remote control communication or Wi-Fi communication which, however, are non-limiting illustrative examples of the wireless communication. For example, wireless communication using Blue Tooth is also adoptable.

Although the above description illustrates the case where the information processing apparatus 10 and the smart device 30 are connected to each other with the wireless router interposed therebetween, the wireless router 40 is not always necessary. The information processing apparatus 10 and the smart device 30 may be directly connected to each other.

Although the above description illustrates the case where the remote control transmitter-receiver 160 of the information processing apparatus 10 is operable to perform transmission and reception, it may be configured as a remote control receiver capable of reception only. On the other hand, the remote control transmitter-receiver 250 of the remote control 20 may be configured as a remote control transmitter capable of transmission only.

Although the above description illustrates the operation performed through pressing of the input key 230, touching to the touch panel 330, or the like; the same effects can be obtained through the operation on the gyroscope 240 or the gyroscope 340. In some circumstances, however, the operation through the input key 230 or the touch panel 330 is preferred because it contributes to simplification of the operation.

The operation on the input key 230 may not necessarily be implemented by pressing. It may be operated based on perception of user's touching thereto.

Although the above description illustrates the case where the displaying of an icon in the special mode is implemented by outlining the icon with a thick red line, this is not limiting. In alternative cases, for example, an icon displayed in the special mode may be highlighted with a darker color as compared with an icon displayed in the normal mode, or an icon displayed in the normal mode may be given a lighter color as compared with an icon displayed in the special mode.

What is claimed is:

1. An electronic device comprising:
a controller that performs a control of, in response to an operation input, selectively executing a plurality of kinds of application software and causing a display to display a plurality of icons each corresponding to each of the plurality of kinds of application software; and
a storage that stores identification information that identifies whether each of the plurality of kinds of application software is normal application software or special application software,
the controller performing a control of causing an icon corresponding to the normal application software to be displayed in a first mode on the display and causing an icon corresponding to the special application software to be displayed in a second mode on the display,
the special application software being selectively executable by a user's operation that is different from an operation performed to execute the normal application software.

2. The electronic device according to claim 1, wherein
the controller performs a control of, in response to an operation input performed with the display displaying the plurality of icons, causing the storage to store identification information indicating that at least one of the plurality of kinds of application software is the special application software.

3. The electronic device according to claim 2, wherein
the controller performs a control of switching a display state between a first display state in which a first set of icons among the plurality of icons is displayed on the display and a second display state in which a second set of icons among the plurality of icons is displayed on the display, and performs a control of causing the display to display an icon corresponding to the special application software in both the first display state and the second display state.

4. The electronic device according to claim 3, further comprising a transmitter that transmits information concerning an icon of the special application software to an operation unit that wirelessly operates the electronic device.
